(19) United States
(12) Patent Application Publication
(10) Pub. No.: US 2002/0089287 A1
(43) Pub. Date: Jul. 11, 2002

(54) Lighting apparatus using microwave

(76) Inventors: Hyun Jung Kim, Seoul (KR); Hyo Sik Jeon, Gwangmyeong (KR)

Correspondence Address: BIRCH STEWART KOLASCH & BIRCH, PO BOX 747, FALLS CHURCH, VA, 22040-0747, US

(21) Appl. No.: 09/986,398

(22) Filed: Nov. 8, 2001

(30) Foreign Application Priority Data
Jan. 8, 2001 (KR) 970/2001

(51) Int. Cl. H01J 65/04

(52) U.S. Cl. 315/39; 315/248

(57) ABSTRACT

In a lighting apparatus using microwave, a lighting apparatus using microwave including a resonator excluding microwave and transmitting a light, a waveguide placed at an internal domain of the resonator and transmitting the microwave, a microwave generating means installed at the side of the resonator and oscillating microwave into the waveguide, and a bulb placed at the center of the resonator and emitting light by generating a plasma by the microwave transmitted through the waveguide is capable of miniaturizing a lighting system and at the same time improving a lighting efficiency.

### BACKGROUND OF THE INVENTION

1. Field of the Invention

The present invention relates to a lighting apparatus using microwave, and in particular to a lighting apparatus using microwave which is capable of emitting lights by applying microwave to an electrodeless bulb.

2. Description of the Conventional Art

A lighting apparatus using microwave emits visible rays or ultraviolet rays by applying microwave to an electrodeless bulb, it has longer life span and better lighting effectiveness than a general incandescent lamp or a fluorescent lamp.

FIG. 1 is a longitudinal sectional view illustrating an internal structure of a lighting apparatus using microwave.

A lighting apparatus using microwave includes a magnetron 1, a waveguide 3 transmitting microwave from the magnetron 1 to a bulb 5, the bulb 5 emitting lights by plasmatizing enclosed materials by the microwave energy transmitted through the waveguide 3, and a resonator 10 placed in front of the waveguide 3 and the bulb 5, excluding the microwave and transmitting the light emitted from the bulb 5.

Particularly, the resonator 10 has a cylindrical shape and has a metal mesh structure in order to exclude microwave while transmitting the light emitted from the bulb 5.

The lighting apparatus using microwave further includes a high voltage generator 7 boosting the voltage of an alternating current and supplying it to the magnetron 1, a cooling unit 9 refrigerating the magnetron 1 and the high voltage generator 7, a reflector 11 intensively reflecting the light emitted from the bulb 5 in the front, and a control unit (not shown) controlling various elements inclduing the high voltage generator 7 and the cooling unit 9.

In the lighting apparatus using microwave, when an operating signal is inputted from the control unit to the high voltage generator 7, the high voltage generator 7 boost the voltage of the AC power and supplies the boosted AC power to the magnetron 1.

The magnetron 1 oscillates by the high voltage supplied from the high voltage generator 7 and generates microwave having a very high frequency, the generated microwave is emitted into the resonator 10 through the waveguide 3, materials enclosed inside the bulb 5 are discharged, accordingly light having an inherent emission spectrum is generated.

The light generated from the bulb 5 reflects in the front through a mirror 12 and the reflector 11 and lights up a space.

However, in the lighting apparatus using microwave in accordance with the conventional art, because the resonator 10 is constructed with a cylindrical metal mesh, most of lights emitted from the bulb 5 transmit the metal mesh and are projected in the front, and part of the lights is reflected on the metal mesh and scattered all over the place inside the resonator 10, accordingly there is a limitation in maximizing a lighting efficiency.

In more detail, because the resonator 10 has the cylindrical shape, a focus of the light reflected onto the metal mesh is not fixed and the light is reflected intricately and scattered all over the place, accordingly the lighting efficiency is lowered due to the loss of the light.

In addition, because the resonator 10 is lengthily projected from the front of the waveguide 3 and a large size of the reflector 11 is installed at the circumstances of the resonator 10, it is difficult to minimize the lighting system.

### SUMMARY OF THE INVENTION

In order to solve above-mentioned problems, it is an object of the present invention to provide a lighting apparatus using microwave which is capable of improving a lighting efficiency and miniaturizing a lighting system by minimizing a loss of light emitted from a bulb by installing a waveguide inside a resonator and installing a bulb at the center of the resonator.

In order to achieve the object of the present invention, a lighting apparatus using microwave includes a resonator excluding microwave and transmitting a light, a waveguide placed at an internal domain of the resonator and transmitting the microwave, a microwave generating means installed at the side of the resonator and oscillating microwave into the waveguide, and a bulb placed at the center of the resonator and emitting light by generating a plasma by the microwave transmitted through the waveguide.

Herein, the resonator has a sphere shape, and the waveguide is installed within the radius of the resonator.

The waveguide has a conic shape, the vertex of the waveguide is placed at the center of the resonator, the cover portion of the waveguide is formed as a curved surface so as to be same as the sphere shape of the resonator and is placed so as to correspond to an external extended portion of the resonator.

The lighting apparatus using microwave having the micro wave generating means further includes a high voltage generator and a casing covering a cooling unit, and the casing is combined and fixed to the cover portion of the waveguide at the external extended portion of the resonator.

The bulb is placed at the center of the resonator, and the microwave generating means is fixed to the waveguide at the external extended portion of the resonator.

### BRIEF DESCRIPTION OF THE DRAWINGS

FIG. 1 is a longitudinal sectional view illustrating a lighting apparatus using microwave in accordance with the conventional art;

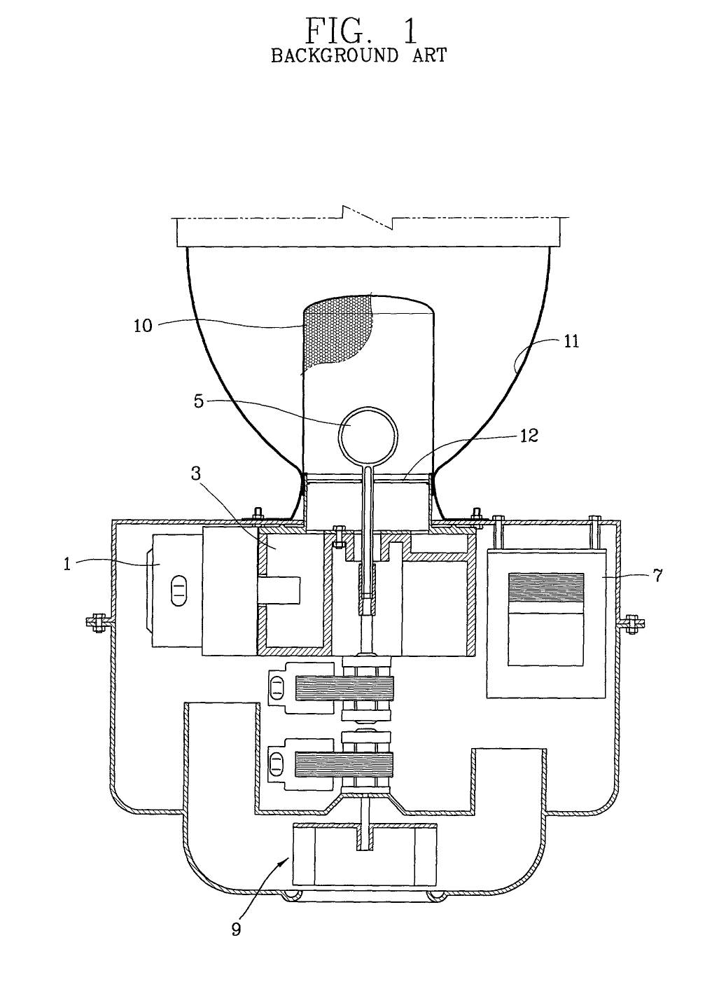

FIG. 2 is a longitudinal sectional view illustrating a lighting apparatus using microwave in accordance with the present invention;

FIG. 3 is a plan view illustrating the lighting apparatus of FIG. 2 taken along the line of A-A; and

FIGS. 4A, 4B, and 4C are plan views of other embodiments illustrating shapes of waveguide in accordance with the present invention.

### DETAILED DESCRIPTION OF THE PREFERRED EMBODIMENT

Hereinafter, a lighting apparatus using microwave in accordance with the present invention will be described with reference to accompanying drawings.

There can be a plurality of embodiments of a lighting apparatus using microwave in accordance with the present invention, hereinafter the most preferable embodiment will be described.

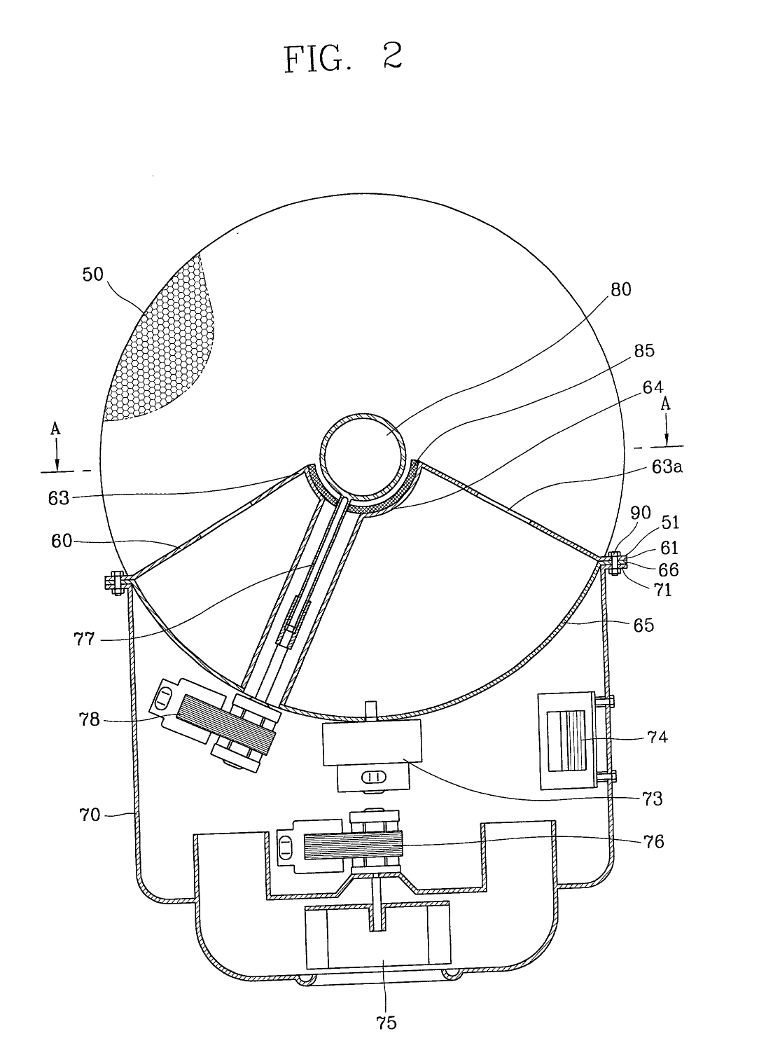

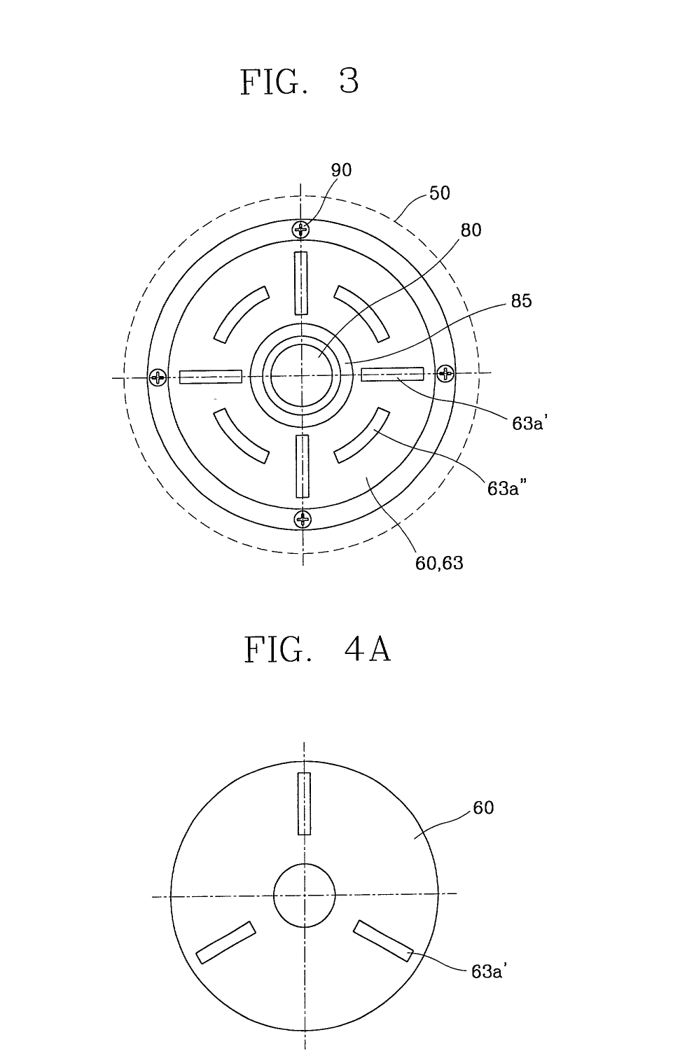

FIG. 2 is a longitudinal sectional view illustrating a lighting apparatus using microwave in accordance with the present invention, and FIG. 3 is a plan view illustrating the lighting apparatus of FIG. 2 taken along the line of A-A.

The lighting apparatus using microwave in accordance with the present invention includes a resonator 50 having a metal mesh structure and an opened lower portion, a waveguide 60 inserted into the opened portion of the resonator 50, placed at the internal area of the resonator 50 having a sphere structure and transmitting microwave, and a casing 70 combined to the bottom portion of the resonator 50 and the waveguide 60.

A plurality of outwardly extended flange portions 51, 61, 66, 71 are respectively formed at the resonator 50, waveguide 60 and casing 70 and adhered tightly by bolts 90.

The resonator 50 has a metal mesh structure constructed with a certain size of hole except the flange portion 51 so as to exclude microwave and transmit light, and the bulb 80 emitting light by generating a plasma by the microwave transmitted through the waveguide 60 is placed at the center of the sphere shaped resonator 50.

The waveguide 60 has a conic shape having an opened bottom portion and is constructed with a body portion 63 placed inside the resonator 50 and a cover portion 65 formed as a curved surface same as the sphere shape of the resonator 50 and combined to the bottom portion of the body portion 63.

At least one outlet 63a is formed at the inclined plane of the body portion 63 in order to transmit the microwave transmitted from the magnetron 73 into the resonator 50.

Particularly, a concave portion 64 hollowed as a hemisphere shape is formed in order to make the bulb 80 place at the vertex of the waveguide 60.

And, a reflecting mirror 85 is installed between the bulb 80 and the concave portion 64 in order to reflect light emitted from the bulb 80 intensively in the front.

Herein, a reflecting layer coated with materials having reflecting elements can be formed at the external surface of the concave portion 64 of the waveguide 60.

A rotation shaft 77 penetrating the waveguide 60 is connected to the bulb 80, and a bulb motor 78 rotating the bulb 80 by being connected to the end portion of the rotation shaft 77 is installed at the bottom surface of the waveguide 60.

The magnetron 73 is installed at the bottom surface 65 of the waveguide 60 inside the casing 70 and oscillates microwave inside the waveguide 60.

A high voltage generator 74 boosting AC current and supplying the boosted AC current to the magnetron 73 is installed at the internal side of the casing 70, and a refrigerating fan 75 and a motor for the refrigerating fan 76 are installed at the lower portion of the casing 70 in order to refrigerate the magnetron 73 and the high voltage generator 74.

In the meantime, as depicted in FIG. 3, three slots 63a′ lengthily formed in the radius direction and three slots 63a″ lengthily formed in the circumference direction are arranged with a certain distance.

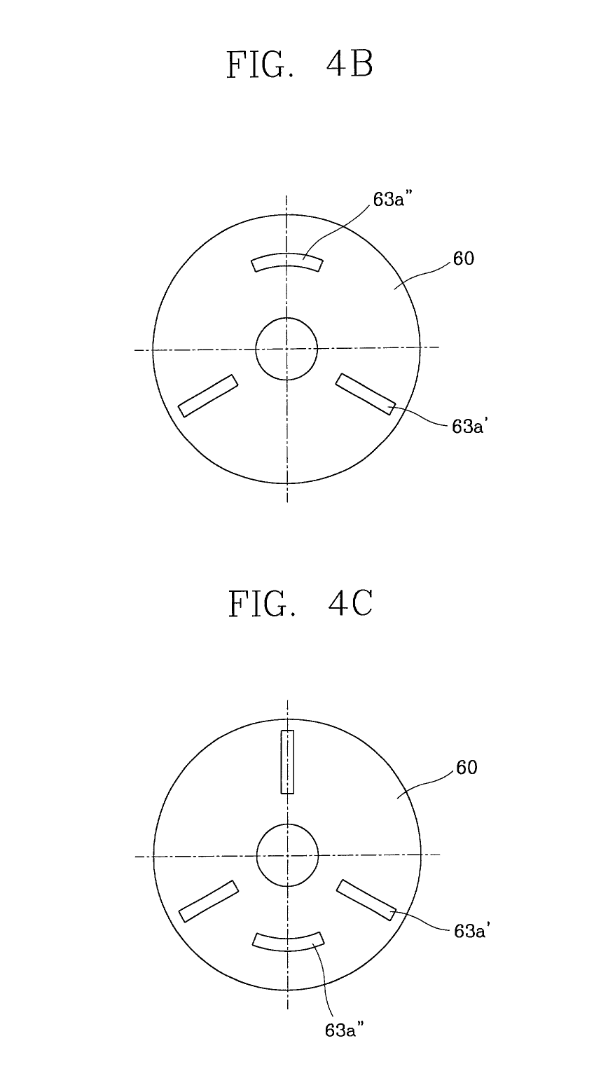

FIGS. 4A, 4B and 4C are plan views of other embodiments illustrating shapes of waveguide in accordance with the present invention.

As depicted in FIG. 4A, in another embodiment of the present invention, three slots 63′ lengthily formed in the radius direction are placed at 120° as the outlet 63a of the waveguide 60.

As depicted in FIG. 4B, in still another embodiment of the present invention, two slots 63′ lengthily formed in the radius direction and one slot 63a″ lengthily formed in the circumference direction are placed at 120° as the outlet 63a of the waveguide 60.

As depicted in FIG. 4C, in yet still another embodiment of the present invention, three slots 63′ lengthily formed in the radius direction and one slot 63a″ lengthily formed in the circumference direction are placed at 120° as the outlet 63a of the waveguide 60.

The operation of the lighting apparatus using microwave in accordance with the present invention will be described.

When the magnetron 73 oscillates microwave, the microwave is transmitted into the waveguide 60 and is radiated inside the resonator through each outlet 63a.

Herein, the microwave emitted inside the resonator 50 performs a resonance motion inside the resonator 50, and generates a plasma and an inherent spectrum by exciting the materials enclosed inside the bulb 80

Most of lights generated in the bulb 80 and reflected onto the reflecting mirror 85 are emitted in the front through the hole of the resonator 50, part of the light reflected onto the metal mesh of the resonator 50 is concentrated on the center of the resonator 50, namely the bulb 80 placed at the focus of the sphere, and is reflected in the front through the reflecting mirror 85, accordingly loss of the light can be reduced.

The lighting apparatus using microwave in accordance with the present invention is capable of improving a lighting efficiency and miniaturizing a lighting system by minimizing loss of light emitted from a bulb by placing the bulb at the center of a resonator having a sphere shape and installing a waveguide inside the resonator.

What is claimed is:

1. A lighting apparatus using microwave, comprising:
a resonator excluding microwave and transmitting a light;
a waveguide transmitting the microwave into the resonator;
a microwave generating means installed on the side of the waveguide and oscillating microwave into the waveguide; and
a bulb placed at the center of the resonator and emitting light by generating a plasma by the microwave transmitted through the waveguide,
wherein said waveguide is placed at an internal domain of the resonator.

2. The apparatus of claim 1, wherein the resonator has a sphere shape, and the waveguide is installed within the radius of the resonator.

3. The apparatus of claim 2, wherein the resonator has an opened portion so as to place the waveguide, and the waveguide is fixed to the resonator by being inserting into the opened portion of the resonator.

4. The apparatus of claim 3, wherein outwardly extended flange portions are respectively formed at the resonator and waveguide, and respectively fixed to the resonator and the waveguide by fixing means.

5. The apparatus of claim 2, wherein the waveguide has a conic shape, the vertex of the waveguide is placed at the center of the resonator, the bottom portion of the waveguide is formed as a curved surface so as to be same as the sphere shape of the resonator and is placed so as to correspond to an external extended portion of the resonator.

6. The apparatus of claim 5, wherein the waveguide is constructed with a conic shaped body portion having an opened bottom portion and a cover portion fixed to the opened bottom portion of the body portion.

7. The apparatus of claim 5, wherein the waveguide has at least one outlet at an inclined plane of the internal area of the resonator in order to transmit microwave into the resonator.

8. The apparatus of claim 7, wherein a plurality of outlets are lengthily formed in the radius direction centering around the vertex of the waveguide.

9. The apparatus of claim 7, wherein the outlet lengthily formed in the radius direction and the outlet lengthily formed in the circumference direction centering around the vertex of the waveguide are arranged.

10. The apparatus of claim 5, wherein the vertex of the waveguide is concave so as to place the bulb.

11. The apparatus of claim 10, wherein a reflecting means is installed between the bulb and the concave portion of the waveguide in order to reflect light emitted from the bulb in the front.

12. The apparatus of claim 11, wherein the reflecting means is a reflecting mirror installed between the bulb and the concave portion of the waveguide.

13. The apparatus of claim 11, wherein the reflecting means is a reflecting layer coated onto the outer surface of the concave portion of the waveguide.

14. The apparatus of claim 1, further comprising:
a casing combined and fixed to the bottom portion of the waveguide at the external region of the extended portion of the resonator in order to cover the microwave generating means, a high voltage generator and a cooling unit.

15. The apparatus of claim 1, wherein the bulb is placed at the center of the resonator.

16. The apparatus of claim 1, wherein the microwave generating means is fixed to the waveguide at the external region of the extended portion of the resonator.

17. The apparatus of claim 1, further comprising
a rotation shaft connected to the bulb and penetrating the waveguide; and
a bulb motor placed at the bottom surface of the waveguide and rotating the bulb by being connected to the end of the rotation shaft.
